(19) United States
(12) Patent Application Publication
(10) Pub. No.: US 2026/0151001 A1
(43) Pub. Date: Jun. 4, 2026

(54) SYSTEMS AND METHODS TO CONTROL HEAT DISTRIBUTION FOR A COOKING DEVICE

(71) Applicant: LOCO-CRAZY GOOD COOKERS, INC., Columbus, GA (US)

(72) Inventors: McDonald PLUMMER, III, Milton, GA (US); Blake LEVIEN, Katy, TX (US); Joseph London TURNER, Butler, GA (US); Qin QINGKUN, Panyu (CN)

(21) Appl. No.: 19/134,315

(22) PCT Filed: Nov. 30, 2022
(86) PCT No.: PCT/CN2022/135649

§ 371 Date: May 30, 2025

(51) Int. Cl. A47J 37/12; F23K 5/00

(52) U.S. Cl. CPC A47J 37/1266; A47J 37/129; F23K 5/005; F23K 5/007; F23K 2400/201

(57) ABSTRACT

Systems (100, 200, 300, 400, 500), methods (700), and devices include a cooking device (102) for providing fuel to one or more burners (106) and heating a cooking liquid (e.g. frying oil or water) in a vessel (108) above the burners (106). The cooking device (102) includes a fuel control system (104) with a heat sink (114) in contact with a wall surface (112) of the vessel (108), a probe (110, 610) coupled to the heat sink (114), and a capillary tube (202) coupled to the probe (110, 610). The fuel control system (104) also includes a fuel valve fluidly coupled to the capillary tube (202) such that heat conducted from the vessel (108) into the heat sink (114) causes fluid in the capillary tube (202) to exert a pressure on the fuel valve, thus regulating the flow of fuel to the burners (106) responsive to the heat conducted from the side wall (112) of the vessel (108). A burner array (402) and/or a heat distribution ring (118) disposed around the bottom of the vessel (108) provide an even heat distribution to the vessel (108).

### BACKGROUND

Gas fueled cooking devices face a variety of challenges to manage heat created by the flames in a safe and effective manner. These types of cooking devices often use a gas burner positioned below a cooking pot to provide heat to the contents inside the cooking pot. However, the gas burner creates unintentional hot spots causing some portions of the contents inside the cooking pot to heat up more rapidly than others. Moreover, a substantial amount of heat is lost to the ambient air of the environment surrounding the cooking device, such that the overall gas-to-heat conversion efficiency suffers. Other components of the cooking devices can be made of metal, such that these components absorb heat from the flame of the gas burner as well as heat conducting from the cooking pot. These unintentionally heated components create a safety hazard for the user who may touch the unintentionally heated component and suffer a burn and further reduce the efficiency of the cooking device.

Furthermore, the uneven heat distribution created by typical cooking devices makes it difficult to manage the cooking liquid temperature with precision. A temperature measurement at one part of the cooking device may not accurately reflect the temperature at other parts of the cooking device, such as the cooking liquid, due to the position of the gas burner below the cooking pot. Moreover, adjustments to the cooking liquid temperature to achieve a desired temperature based on these measurements often overcompensate-causing the temperature of the cooking liquid to surpass the intended temperature-because of the delayed time it takes for heat at the bottom of the cooking pot to distribute throughout the cooking pot and cooking liquid. Cooking devices struggle to maintain the cooking liquid at an intended temperature with precision once the intended temperature is reached. Rather, the temperature of the cooking liquid tends to fluctuate above and below the intended temperature, sometimes up to 10° Fahrenheit or more in either direction.

Additionally, some types of cooking devices have additional safety concerns. For instance, large oil fryer cooking devices, such as turkey fryers, can be dangerous to operate due to the extreme temperatures of the cooking oil in the cooking pot, and the exposure of flammable oil to open flame. These types of cooking devices typically include a cooking pot that is detached from the base, which can cause the hot oil to spill and burn the user.

It is with these observations in mind, among others, that the presently disclosed technology was conceived.

### BRIEF SUMMARY

The presently disclosed technology addresses the foregoing problems by providing systems, devices, and methods for providing fuel to one or more burners and/or heating a cooking liquid of a cooking device. In some instance, a cooking device includes a vessel operable to receive a cooking liquid; one or more burners disposed below the vessel; and/or a fuel control system for providing fuel to the one or more burners and a corresponding heat distribution to a bottom portion of the vessel. The fuel control system can include a heat sink in contact with a wall surface of the vessel; a capillary tube, containing a fluid, coupled to the heat sink; and/or a fuel valve operable to provide fuel to the one or more burners, the fuel valve controlled by a pressure of the fluid in the capillary tube caused by the heat sink, such that an amount of fuel provided to the one or more burners is responsive to heat conducting from the heat sink.

In some instances, the heat sink converts a heat of the cooking liquid into the heat conducting from the heat sink to create the pressure in the capillary tube which pushes on a diaphragm of the fuel valve. Moreover, the cooking device can further include a dial for providing a set-point temperature value to the fuel control system, the fuel valve being operable to provide the fuel to the one or more burners responsive to a measured temperature value being less than the set-point temperature value. The cooking device can also include a heat distribution ring disposed around a bottom portion of the vessel. For instance, the heat distribution ring can include an exterior wall spaced apart from the bottom portion of the vessel by an upper rim. The upper rim can include a non-vertical surface circumscribing the vessel. The non-vertical surface of the upper rim can include a plurality of vent openings. In some scenarios, the plurality of vent openings has an even spacing on a first portion of the non-vertical surface, and a second portion of the non-vertical surface where the heat distribution ring is traversed by the capillary tube omits a vent opening.

Furthermore, the cooking device can further include a stand assembly having one or more legs, with the vessel operable to receive the cooking liquid securely fixed to the stand assembly such that the vessel is immovable relative to the stand assembly. The stand assembly can also include a plurality of legs securely fixed to a heat distribution surface disposed around the bottom portion of the vessel.

In some examples, a cooking device includes a vessel operable to receive a cooking liquid; one or more burners disposed below the vessel; and/or a fuel control system for providing fuel to the one or more burners and a corresponding heat distribution to a bottom portion of the vessel. The fuel control system can include a fuel valve operable to provide fuel to the one or more burners from a fuel source; and/or a capillary tube, containing a fluid, coupled to a heat sink in contact with a wall surface of the vessel, such that the heat sink conducts heat from the cooking liquid into the capillary tube to create a pressure on the fuel valve.

In some examples, the pressure on the fuel valve causes an amount of fuel provided to the one or more burners to be responsive to heat conducting from the heat sink. Furthermore, the cooking device can include the cooking liquid, the cooking liquid being a frying oil or water. The one or more burners can include a burner array operable to generate a flame panel below the vessel. Additionally or alternatively, the cooking device can have a digital control system including a processor, a memory device, and computer-readable instructions that, when executed by the processor, cause the fuel control system to perform various operations. For instance, the computer-readable instructions can cause the cooking device to receive a set-point temperature value from a user input; determine whether a real-time temperature value measured by one or more temperature sensors is above the set-point temperature value; and/or determine whether to close the fuel valve based on the real-time temperature value being above the set-point temperature value.

Furthermore, the cooking device can further include a secondary burner, and the computer-readable instructions, when executed by the processor, can cause the fuel control system to close the fuel valve while continuing to provide fuel to the secondary burner. In some instances, the secondary burner is a pilot light, and the cooking device further includes a heat distribution shield disposed over the pilot light to distribute heat from the pilot light onto the bottom portion of the vessel.

In some examples, a method of heating a cooking liquid includes receiving a set-point temperature value at a fuel control system of a cooking device; and/or heating a heat sink with heat from a cooking liquid held by a vessel of the cooking device, the heat sink being in contact with a wall surface of the vessel. The method can further include transferring the heat from the heat sink to a capillary tube to cause an expansion of a fluid inside the capillary tube; and/or adjusting a fuel valve of the fuel control system using the expansion of the fluid inside the capillary tube to apply pressure on a diaphragm fluidly coupled to one or more burners disposed below the vessel, an amount of fuel provided to the one or more burners by the fuel valve being responsive to heating the heat sink.

In some instances, the method further includes detecting, with one or more sensors thermally coupled to the cooking liquid, a real-time temperature value of the cooking liquid; determining that the real-time temperature value is greater than the set-point temperature value; and/or closing the fuel valve of the fuel control system in response to the real-time temperature value being greater than the set-point temperature value while continuing to provide fuel to an ignited secondary burner.

Additionally, in some examples, the method further includes detecting, with one or more sensors thermally coupled to the cooking liquid, a real-time temperature value corresponding to the cooking liquid; and/or retrieving a predetermined threshold value, the predetermined threshold value being between 375° and 450° Fahrenheit. The method can further include determining whether the real-time temperature value is above the predetermined threshold value; and/or closing the fuel valve in response to determining whether the real-time temperature value is above a predetermined threshold value, the predetermined threshold value being between 375° and 450° Fahrenheit.

The foregoing is intended to be illustrative and is not meant in a limiting sense. Many features of the embodiments may be employed with or without reference to other features of any of the embodiments. Additional aspects, advantages, and/or utilities of the presently disclosed technology will be set forth in part in the description that follows and, in part, will be apparent from the description, or may be learned by practice of the presently disclosed technology.

### BRIEF DESCRIPTION OF THE DRAWINGS

FIG. 1 illustrates an example system including a cooking device with a fuel control system for providing fuel to one or more burners.

FIG. 2 illustrates an example system including a cooking device with a fuel control system including a probe thermally coupled to a fuel valve with a capillary tube, which can form at least a portion of the system depicted in FIG. 1.

FIG. 3 illustrates an example system including a cooking device with a fuel control system including a protective control cover, which can form at least a portion of the system depicted in FIG. 1.

FIG. 4 illustrates an example system including a cooking device with a fuel control system including a burner array, which can form at least a portion of the system depicted in FIG. 1.

FIG. 5 illustrates an example system including a cooking device with a fuel control system including a heat distribution ring, which can form at least a portion of the system depicted in FIG. 1.

FIG. 6 illustrates an example method to provide fuel to one or more burners and heat a cooking liquid using a fuel control system, which can be performed by the systems depicted in FIGS. 1-5.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein.

Systems, methods, and devices disclosed herein improve techniques for controlling the flow of fuel to the burner(s) of a cooking device and controlling the corresponding heat distribution and temperature of a cooking liquid in the cooking device. In some instances, the cooking device includes a cooking vessel disposed above the burner(s), and a fuel control system to increase or decrease the amount of fuel provided to the burner(s). The fuel control system can include components for monitoring a temperature of the cooking liquid via heat absorption through the side wall of the vessel.

For instance, a probe can be attached to (e.g., in contact with) a heat sink which, in turn, is attached to (e.g., in contact with) the side wall of the vessel. The probe can be thermally coupled to a first end of a capillary tube, so as the heat sink and probe heat up due to the heat conducting through the side wall of the vessel, a fluid inside the capillary tube expands. A second end of the capillary tube can couple to a diaphragm of a fuel valve that controls the flow of fuel to the burners. The expansion of the fluid inside the capillary tube creates a pressure on the diaphragm, causing the fuel valve to partially close and reduce an amount of fuel provided to the burner(s). Additionally, as the temperature of the cooking liquid begins to drop, the corresponding heat conducted into the capillary tube drops, and the pressure on the diaphragm decreases. This can cause the fuel valve to at least partially open and close due to small or granular changes in temperature of the cooking liquid with a near immediate reaction time.

As such, the temperature of the cooking liquid can be precisely maintained at a set-point temperature value. The fuel control system can provide “proportional control” over the cooking liquid temperature in that the pressure exerted on the fuel valve is proportional to the heat absorbed by the heat sink (e.g., in accordance with the ideal gas law). As such, the temperature of the cooking liquid can be fine-tuned to stay at the set-point temperature value by slightly adjusting the fuel valve with the capillary tube pressure, and can automatically adjust the fuel provided to the flame.

Furthermore, the cooking device can include multiple components to reduce heat loss of the heating system while creating a more even heat distribution. For instance, the cooking device can include a heat distribution ring disposed around a bottom portion of the vessel. The heat distribution ring can at least partially enclose the bottom portion of the vessel as well as the flame created by the burner(s). For instance, the heat distribution ring can include one or more heat distribution surfaces, such as a vertically-aligned sidewall and/or an upper rim surface. These heat distribution surfaces can absorb and/or capture heat that would otherwise escape from the bottom this area. The heat distribution ring can be spaced apart from the side wall of the vessel to create an air buffer between the vessel and the distribution ring. The upper rim surface can include a plurality a vent openings to direct the heated air of the air buffer up the sides of the vessel. Moreover, the burners of the cooking device can have a configuration that further improves the heat distribution at the bottom portion of the vessel. For instance, the burner(s) can be arranged as a burner array including a plurality of rows of burners adjacently aligned. As such, the burner array can create a flame panel (e.g., having a rectangular profile) rather than a flame ring created by other burner configurations (e.g., a burner ring).

Additionally, in some instances, the vessel is securely fixed to a stand assembly. This can prevent accidental spillage of the heated cooking liquid by preventing movement of vessel relative to the stand assembly. The vessel being immovable relative to the stand assembly also prevents damage to the capillary tube that may otherwise occur if the vessel were to separate from the stand assembly.

Additional advantages will become apparent from the disclosure herein.

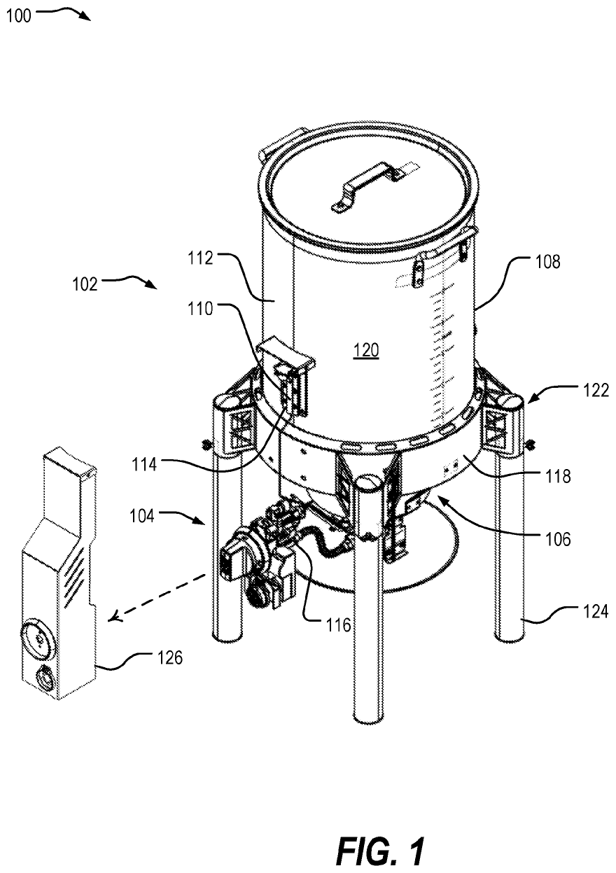

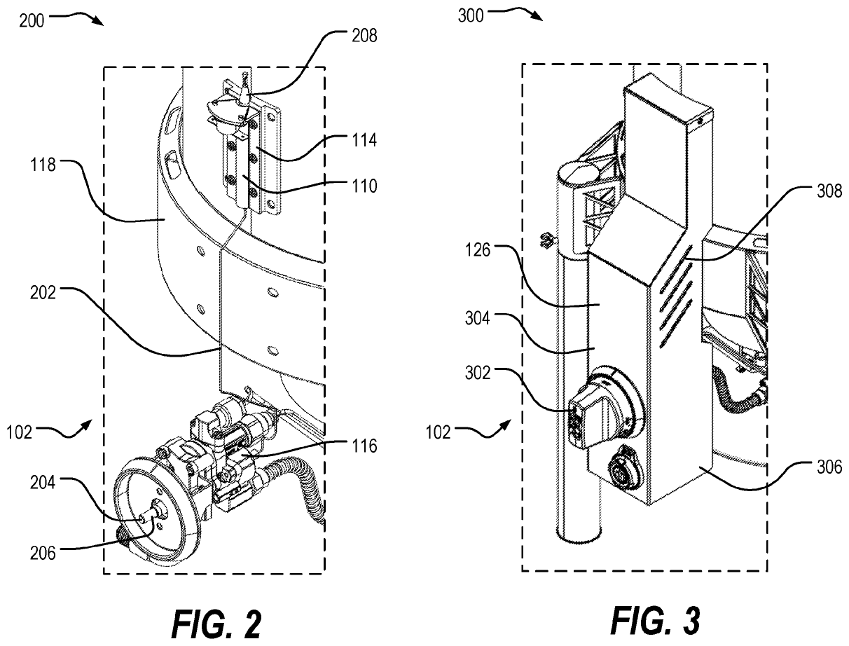

FIG. 1 illustrates an example system 100 including a cooking device 102 with a fuel control system 104 for providing fuel to one or more burners 106 disposed below a vessel 108. The vessel 108 can be operable to hold a cooking fluid (e.g., a frying oil or water) such that the one or more burners 106 provide a heat to the cooking fluid via a heat distribution of flame contacting a bottom portion of the vessel 108. The fuel control system 104 can include a probe 110 attached to a wall surface 112 (e.g., an exterior wall) of the vessel 108 (e.g., or another component of the cooking device 102) and/or mounted to a heat sink 114 coupled to the wall surface 112. The probe can conduct heat from the cooking fluid to a capillary tube (e.g., capillary tube 202 discussed in greater detail below regarding FIG. 2) to control a fuel delivery to the one or more burners 106. The fuel delivery can be from a fuel source, such as a propane tank and/or gas outlet hose (e.g., with a connector for coupling to the fuel control system 104).

To control the flow of fuel, the capillary tube can contain a fluid (e.g., oil) that expands as the capillary tube is heated by the cooking oil (via heat conducted through the wall surface 112 and the heat sink 114). The expansion can cause the fluid to travel down the capillary tube and/or exert a pressure against a diaphragm of a fuel valve contained in a manifold 116 of the fuel control system 104. This pressure can adjust (e.g., decrease) an amount of fuel provided to the burners responsive to the heat of the cooking oil, as monitored by the arrangement of heat transfer components of the fuel control system 104.

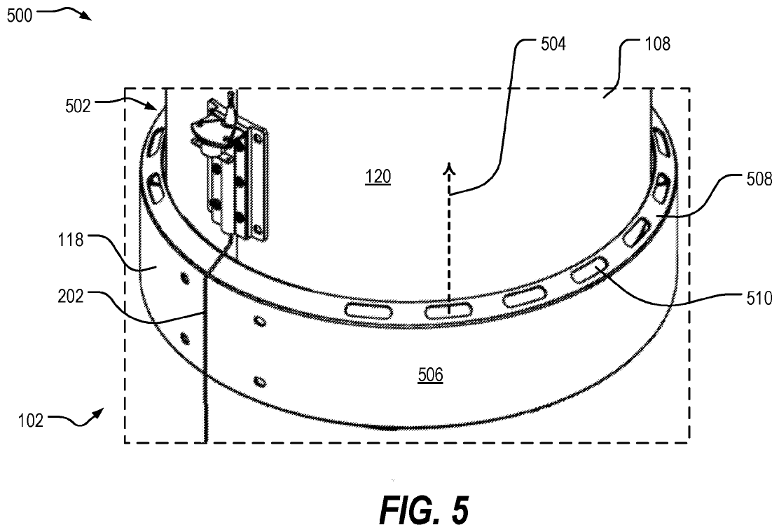

In some examples, the cooking device 102 includes a heat distribution ring 118 disposed around the bottom portion of the cooking device 102. The heat distribution ring 118 can wrap around the area of the cooking device 102 receiving the heat distribution from the one or more burners 106 to prevent heat loss from the bottom portion of the vessel 108, while directing heat up the side wall 120 of the vessel 108. The heat distribution ring 118 is discussed in greater detail below regarding FIG. 5. Furthermore, the cooking device 102 can include a stand assembly 122 including a plurality of support legs 124 for maintain the cooking device 102 in a stable, upright position. The stand assembly 122 can comprise the plurality of support legs 124 coupled to the heat distribution ring 118 and/or the vessel 108. In some scenarios, the vessel 108 can be fixedly or immovably secured to the heat distribution ring 118 and the side wall 120 can be fixedly or immovably secured to the heat distribution ring 118 (e.g., and, in turn, the vessel 108). For instance, these components can be welded, glued, screwed, and/or bolted together. Additionally or alternatively one or more of the stand assembly 122, the heat distribution ring 118, and/or the vessel can be integrally formed a single unit. By securely fixing these components together, the cooking device 102 can be more stable and have improved safety over other cooking devices with a removable vessel. In some instances, the cooking device 102 includes a drain proximate to the bottom portion of the vessel 108 for removing the cooking fluid, such that the cooking fluid can be emptied from the vessel without needing to separate the vessel 108 from the heat distribution ring 118 and/or the stand assembly 122 to turn the vessel 108 upside down.

Furthermore, the cooking device 102 can include a control cover 126 removably coupled to the vessel 108, the heat distribution ring 118, and/or the fuel control system 104. For instance, the control cover 126 can include an elongated body formed by a plurality of sidewalls (e.g., planar sidewalls) for covering and protecting the fuel control system 104, as discussed in greater detail below regarding FIG. 3.

Although the technology disclosed herein is generally discussed with regard to a fryer cooking device having a single vessel with the stand assembly, it is to be understood that the technology can have other applications, such as a water boiler, a double vessel cooker, a rolling fryer cart, and the like.

FIGS. 2 and 3 illustrate example systems 200 and 300 including the cooking device 102 with the fuel control system 104 for providing fuel to the burner(s) 106. FIG. 2 illustrates the cooking device 102 with the control cover 126 removed, and FIG. 3 illustrates the cooking device 102 with the control cover 126 secured to the cooking device 102 positioned over the fuel control system 104. It should be clear to one skilled in the art that the systems 200 and 300 can form at least a portion of the system 100 depicted in FIG. 1.

In some instances, the manifold 116 of the fuel control system 104 houses a plurality of fuel valves, chambers, switches, wires and/or circuitry. One or more fuel valves in the manifold 116 can control an amount of fuel provided to the burner(s) 106. A capillary tube 202 coupled (e.g., thermally coupled) to the probe 110 can extend from the probe 110 (e.g., from the bottom of the probe 110) down the side wall 120 of the vessel 108, over a portion of the heat distribution ring 118, and into the manifold 116 below the heat distribution ring 118. The capillary tube 202 can contain a fluid (e.g., an oil) that absorbs heat conducted from the probe 110 and/or the heat sink 114 to which the probe 110 is mounted. The heat sink 114, in some instances, is an aluminum or aluminum alloy block. In response to absorbing the heat, the fluid in the capillary tube expands and/or the pressure within the capillary tube increases. This expansion can cause the fluid to travel down the capillary tube 202. Moreover, the enclosed space of the capillary tube 202 can cause an increase in the pressure as the fluid fills the space inside the capillary tube 202. An end of the capillary tube can couple to a diaphragm of one of the fuel valves inside the manifold 116 (e.g., a primary fuel valve), such that the pressure of the expanding fluid pushes against the diaphragm, causing the fuel valve to at least partially close, reducing the amount of fuel provided to the burner(s) 106. The threshold at which the pressure causes the fuel valve to close can be set by a dial 204. The dial 204 can convert a user input (e.g., received via a knob 302 attached to a dial stem 206) into a set-point temperature value by adjusting a valve or spring in the manifold 116 to set a temperature value at which the pressure causes the diaphragm to close. In this way, the set-point temperature value can be stored mechanically in the manifold 116. Additionally or alternatively, the cooking device 102 can include a digital control system that stores the set-point temperature value at a database, and uses voltage signaling to adjust the fuel valve threshold value accordingly.

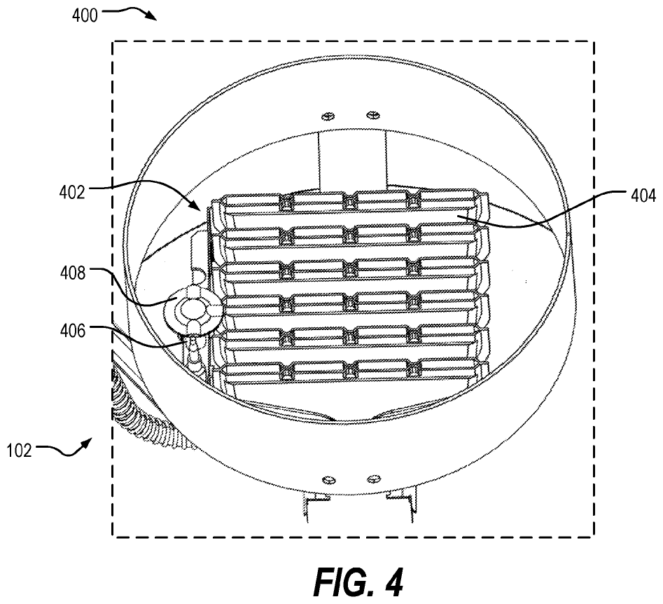

As such, the fuel control system 104 can regulate the heat distribution of the burner(s) 106 and the corresponding temperature of the cooking fluid. The temperature of the cooking fluid can be maintained, in real-time, once the set-point temperature value is reached by closing the valve providing fuel to the burner(s) 106. The burner(s) 106 can be a primary burner and, upon closing the valve to the primary burner, the fuel control system 104 can continue to provide fuel to a secondary burner (e.g., a pilot light), which can be ignited prior to adjusting the primary burner as well as after adjusting the primary burner, as discussed in greater detail below regarding FIG. 4.

Furthermore, the fuel control system 104 can include a temperature limit switch 208 to close the fuel valve and cutoff the primary burner flame in response to a maximum temperature value being reached independent of the set-point temperature value. The maximum temperature value can be between 375°-450° Fahrenheit. The temperature limit switch can provide an improvement to safety by preventing the cooking liquid and/or the cooking device 102 from overheating (e.g., heating past a cooking temperature range of 375°).

Turning to FIG. 3, the cooking device 102 can include the control cover 126 for covering and protecting the fuel control system 104. The control cover 126 can be removably attached to the cooking device 102 at various points on the cooking device 102 (e.g., via snap-fits, accessible screws, etc.). The control cover 126 can have one or more attachment points on the heat distribution ring 118. Furthermore, the control cover 126 can include an elongated body 304 formed by a plurality of sidewalls 306. The elongated body 304 can be positioned along the cooking device 102 extending from the side wall 120 of the vessel 108, over a portion of the heat distribution ring 118, and over the manifold 116. An upper portion of the control cover 126 for covering and protecting the probe 110 and the heat sink 114 can have a first width that is less than a second width of a lower portion of the control cover 126 that covers and protects the manifold 116. As such the elongated body 304 of the control cover 126 can have a varying width that protects multiple components of the fuel control system 104. One or more vents 308 can be formed into the sidewall(s) 306 to improve/regulate the heat distribution occurring below the vessel 108. In some instances, the dial 204 can couple to the dial stem 206 extending from the manifold 116 through a hole in the control cover 126. The dial 204 can be used to provide the set-point temperature value to the fuel control system 104, as discussed above.

FIG. 4 illustrates an example system 400 including the cooking device 102 with the fuel control system 104 for providing fuel to the burner(s) 106. As depicted in FIG. 4, the burner(s) 106 can be a burner array 402 to form a flame panel on the bottom portion of the vessel 108. The system 400 can form at least a portion of the system 100 depicted in FIG. 1.

In some examples, the burner array 402 can be the primary burner for providing the flame panel to the bottom portion of the vessel 108. For instance, the burner array 402 can be used to increase the temperature of the cooking liquid to the set-point temperature value. The burner array 402 can include a plurality of burner rows 404, with a same amount of burners per row. For instance, the burner array 402 can include two, three, four, five, six, seven, eight, nine, or ten rows of burners (e.g., or more), and the individual rows of burners can each have one, two, three, four, or five burners (e.g., or more). In some scenarios, the burner array 402 includes six rows of burners that have four burners per row.

In some instances, the one or more burner(s) 106 include the secondary burner 406 in addition to the primary burner (e.g., the burner array 402). The secondary burner 406 can be a multi-functional burner by operating as a pilot light for the burner array 402, while also providing temperature maintenance once the set-point temperature value is reached. For example, in response to the cooking liquid reaching the set-point temperature (e.g., based on capillary tube 202 expansion and/or temperature data collected by one or more temperature sensors disposed in the vessel 108 and/or attached to the vessel 108), the cooking device 102 can close a primary fuel valve providing fuel to the burner array 402 while continuing to provide fuel to the secondary burner 406 (e.g., by keeping a secondary valve providing fuel to the secondary burner 406 open). The secondary burner 406 can continue to provide a flame that contributes to the heat distribution after the burner array 402 is turned off, such that the cooking liquid temperature is maintained at (e.g., and/or within a predetermined threshold range of) the set-point temperature value. A flame shield 408 can be disposed over the secondary burner 406 to conduct/distribute the heat from the flame of the secondary burner 406 onto the bottom portion of the vessel 108 to maintain the cooking liquid temperature. Once the cooking liquid temperature drops below the threshold of the set-point temperature value, a retraction of the fluid in the capillary tube 202 and/or a reduction in pressure on the primary fuel valve can open the primary fuel valve and reignite the burner array 402. These operations can be performed using the thermodynamic properties of the probe 110 and the capillary tube 202 additionally or alternatively to using a digital control system, as discussed above. In some scenarios, using the burner array 402 (e.g., rather than a burner ring) can create the flame panel (e.g., a flame with a rectangular cross) instead of a flame ring, which makes the heat distribution more even as well as having higher British Thermal Units (BTU)s.

FIG. 5 illustrates an example system 500 including the cooking device 102 with the fuel control system 104 for providing fuel to the burner(s) 106. As depicted in FIG. 5, the cooking device 102 can include the heat distribution ring 118 at least partially enclosing a bottom portion 502 of the vessel 108. The system 500 can form at least a portion of the system 100 depicted in FIG. 1.

In some instances, the heat distribution ring 118 is an outer shell extension or outer body extension that wraps around the bottom portion 502 of the vessel 108. The heat distribution ring 118 can concentrate the heat distribution from the burner(s) 106 into a vertical dissipation direction 504 around a bottom end of the vessel 108. The heat distribution ring 118 can have an exterior wall 506 spaced a distance apart from the bottom portion 502. For instance, an upper rim 508 of the heat distribution ring 118 can extend from the exterior wall 506 to the side wall 120 of the vessel. The upper rim 508 can form a non-perpendicular angle with the side wall 120 and the exterior wall 506 such that the upper rim 508 creates a slant on the top of the heat distribution ring 118. The exterior wall 506 can have a vertically aligned surface that is substantially parallel to the vertically aligned side wall 120 of the vessel 108. The side wall 120 of the vessel 108 can have a first circular, horizontal cross-section with a first diameter, and the heat distribution ring 118 can have a second circular, horizontal cross-section with a second diameter greater than the first diameter, creating a gap between the heat distribution ring 118 and the bottom portion 502 of the vessel 108. Furthermore, the exterior wall 506 can extend beyond or past the bottom portion 502 to at least partially enclose the flame panel and/or the one or more burner(s) 106 positioned below the vessel 108.

In some examples, the upper rim 508 is a non-vertical surface (e.g., a slanted surface) that circumscribes the vessel 108. The upper rim 508 can attach to the vessel 108 at an edge of the upper rim 508 (e.g., via a weld, glue, bolts, etc.). Additionally or alternatively, the heat distribution ring 118 can include other attachment points to the vessel 108, such as one or more rods extending from an inner surface of the exterior wall 506 to the side wall 120.

The surface of the upper rim 508 can include a plurality of vent openings 510. For instance, the vent openings 510 can be evenly spaced around the upper rim 508. The vent openings 510 can be circular, rectangular (e.g., with rounded corners), square, ovals, or any other shape. In some examples, the plurality of vent openings 510 are evenly spaced around a first portion of the upper rim 508. A second portion of the upper rim 508 can omit the vent openings 510 or have a larger gap between vent openings 510 than the first portion. The second portion of the upper rim 508 omitting vent openings 510 can define a pathway for the capillary tube 202 to traverse the heat distribution ring 118. The pathway for the capillary tube 202 defined by the second portion of the upper rim 508 can omit the vent openings 510 such that hot air is not directed onto the probe 110 above the second portion of the upper rim 508 (e.g., directed away from the probe 110, or vertical and parallel to the probe 110). In this way, the heat distribution ring 118 can create an air buffer around the bottom portion 502 of the vessel 108. The flame from the burner(s) 106 can heat up the air buffer to provide an even heat distribution around the bottom portion 502 via convection in addition to the direct flame contact on the bottom portion 502. Moreover, as the air buffer increases in temperature, this heated air can be directed out the vent openings 510 in the vertical direction 504 along the side wall 120 of the vessel 108. Pushing hot air through the vent openings 510 can further cause the heat generated by the burner(s) 106 to be more evenly distributed on the vessel 108.

The fuel control system 104 can include a controller for regulating the heat distribution cooking fluid temperature of the cooking device 102. As discussed above, the controller can be a mechanical/analog controller formed by various valves, junctions, chambers, and tensioning springs contained in the manifold 116. Additionally or alternatively, the controller can include digital components, such as a processor, a memory storage device (e.g., a non-transitory storage device), and computer-readable instructions stored on the memory storage device that, when executed by the processor, cause the cooking device 102 to perform the operations discussed herein.

For instance, the controller can receive the user input generating the set-point temperature value via the dial 204 (e.g., an analog dial or a digital dial). The set-point temperature value can be stored by the controller, for instance, as an adjustment to one of the valves or tensioning springs in the manifold 116, and/or as a data value stored in the memory storage device. The controller can determine whether a real-time temperature value (e.g., measured temperature value) associated with the cooking liquid is above or below the set-point temperature value (e.g., or a predetermined threshold value based on the set-point temperature value). For instance, the cooking device 102 can include one or more temperature sensors (e.g., thermocouples) disposed on the vessel 108 to provide temperature data to the controller. The controller can determine whether to open or close (e.g., or partially open or close) the primary fuel valve based on whether the real-time temperature value is above or below the set-point temperature value. In some instances, the cooking device 102 can close the primary valve responsive to comparing the real-time temperature value to the set-point temperature value while continuing to provide fuel to the secondary burner 406.

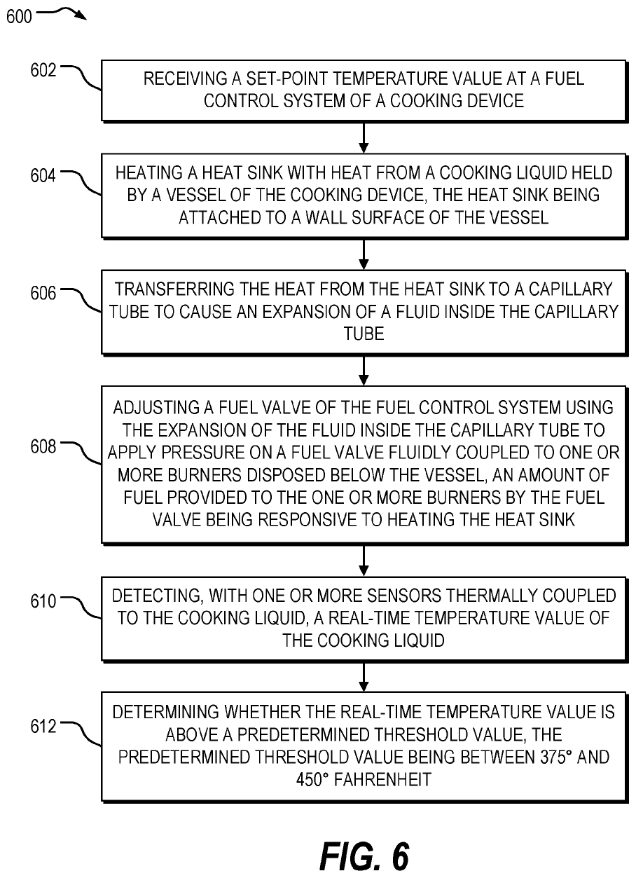

FIG. 6 illustrates a cooking device with a heat sink in contact with a sidewall 112 of a vessel (e.g., vessel 108 of FIG. 1), in accordance with certain aspects of the present disclosure. The heat sink may include a heat sink part 614 disposed above a heat sink part 618. As shown, heat sink part 614 may be held in contact with the sidewall 112 without being attached to the sidewall 112. Heat sink part 614 may be held in contact with the sidewall 112 using a bracket 616 which may be coupled to a housing (not shown in FIG. 6) such as control cover 126 described with respect to FIG. 1. A probe 610 (e.g., corresponding to probe 110) may be disposed through an opening in heat sink part 614, as shown. The probe 610 may also be disposed through an opening in heat sink part 618 and coupled to the capillary tube 202. The heat sink is keyed to maintain a good thermal connection between the sensor (e.g., probe 610) and the sidewall 112. Since the heatsink is not attached to the sidewall 112, the vessel may be readily lifted off by a user while maintaining thermal conductivity between the vessel and the probe.

FIG. 7 illustrates an example method 700 for providing fuel to one or more burners 106 and/or heating a cooking liquid. The method 700 can be performed by any of the systems 100-500 discussed herein.

In some instances, at operation 702, the method 700 receives a set-point temperature value at a fuel control system of a cooking device. At operation 704, the method 700 can heat a heat sink with heat from a cooking liquid held by a vessel of the cooking device, the heat sink being in contact with a wall surface of the vessel. At operation 706, the method 700 can transfer the heat from the heat sink to a capillary tube to cause an expansion of a fluid inside the capillary tube. At operation 708, the method 700 can adjust a fuel valve of the fuel control system using the expansion of the fluid inside the capillary tube to apply pressure on a fuel valve fluidly coupled to one or more burners disposed below the vessel, an amount of fuel provided to the one or more burners by the fuel valve being responsive to heating the heat sink. At operation 710, the method 700 can detect, with one or more sensors thermally coupled to the cooking liquid, a real-time temperature value of the cooking liquid. At operation 712, the method 700 can determine whether the real-time temperature value is above a predetermined threshold value, the predetermined threshold value being between 375° and 450° Fahrenheit.

While examples described herein are described with respect to a cooking device having cooking liquid, the aspects of the present disclosure may be applied to any suitable cooking device, such as a griddle or a smoker. For example, some aspects provide an analog griddle that may include analog components such as an analog controller (e.g., for regulating the heat of the griddle) and analog dials (e.g., knobs) as described herein. In some aspects, the heat distribution and temperature control techniques described herein may be applied to a smoker.

It is to be understood that the specific order or hierarchy of operations in the method 700 depicted in FIG. 7 and throughout this disclosure are instances of example approaches and can be rearranged while remaining within the disclosed subject matter. For instance, any of the operations depicted in FIG. 7 and throughout this disclosure can be omitted, repeated, performed in parallel, performed in a different order, and/or combined with any other of the operations depicted in FIG. 7 and throughout this disclosure. Moreover, any of the example operations of the methods illustrated in FIGS. 1-7, or the components thereof, can be combined together.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A cooking device comprising:
a vessel operable to receive a cooking liquid;
one or more burners disposed below the vessel; and
a fuel control system for providing fuel to the one or more burners and a corresponding heat distribution to a bottom portion of the vessel, the fuel control system including:
a heat sink in contact with a wall surface of the vessel;
a capillary tube, containing a fluid, coupled to the heat sink; and
a fuel valve operable to provide fuel to the one or more burners, the fuel valve controlled by a pressure of the fluid in the capillary tube caused by the heat sink, such that an amount of fuel provided to the one or more burners is responsive to heat conducting from the heat sink.

2. The cooking device of claim 1, wherein the heat sink converts a heat of the cooking liquid into the heat conducting from the heat sink to create the pressure in the capillary tube which pushes on a diaphragm of the fuel valve.

3. The cooking device of claim 1, further comprising a dial for providing a set-point temperature value to the fuel control system, the fuel valve is operable to provide the fuel to the one or more burners responsive to a measured temperature value being less than the set-point temperature value.

4. The cooking device of claim 1, further comprising a heat distribution ring disposed around a bottom portion of the vessel.

5. The cooking device of claim 4, wherein the heat distribution ring includes an exterior wall spaced apart from the bottom portion of the vessel by an upper rim.

6. The cooking device of claim 5, wherein the upper rim includes a non-vertical surface circumscribing the vessel.

7. The cooking device of claim 6, wherein the non-vertical surface includes a plurality of vent openings.

8. The cooking device of claim 7, wherein the plurality of vent openings have an even spacing on a first portion of the non-vertical surface, and a second portion of the non-vertical surface where the heat distribution ring is traversed by the capillary tube omits a vent opening.

9. The cooking device of claim 4, further comprising a stand assembly including one or more legs, the vessel operable to receive the cooking liquid is securely fixed to the stand assembly such that the vessel is immovable relative to the stand assembly.

10. The cooking device of claim 9, wherein the stand assembly includes a plurality of legs securely fixed to a heat distribution surface disposed around the bottom portion of the vessel.

11. A cooking device comprising:
a vessel operable to receive a cooking liquid;
one or more burners disposed below the vessel; and
a fuel control system for providing fuel to the one or more burners and a corresponding heat distribution to a bottom portion of the vessel, the fuel control system including:
a fuel valve operable to provide fuel to the one or more burners from a fuel source; and
a capillary tube, containing a fluid, coupled to a heat sink in contact with a wall surface of the vessel, such that the heat sink conducts heat from the cooking liquid into the capillary tube to create a pressure on the fuel valve.

12. The cooking device of claim 11, wherein the pressure on the fuel valve causes an amount of fuel provided to the one or more burners to be responsive to heat conducting from the heat sink.

13. The cooking device of claim 12, further comprising the cooking liquid, the cooking liquid being a frying oil or water.

14. The cooking device of claim 11, wherein the one or more burners include a burner array operable to generate a flame panel below the vessel.

15. The cooking device of claim 11, further comprising a digital control system including a processor, a memory device, and computer-readable instructions that, when executed by the processor, cause the fuel control system to perform operations including:
receiving a set-point temperature value from a user input;
determining whether a real-time temperature value measured by one or more temperature sensors is above the set-point temperature value; and
determining whether to close the fuel valve based on the real-time temperature value being above the set-point temperature value.

16. The cooking device of claim 15, further comprising a secondary burner, and the computer-readable instructions, when executed by the processor, cause the fuel control system to close the fuel valve while continuing to provide fuel to the secondary burner.

17. The cooking device of claim 16, wherein the secondary burner is a pilot light, and further comprising a heat distribution shield disposed over the pilot light to distribute heat from the pilot light onto the bottom portion of the vessel.

18. A method of heating a cooking liquid, the method including:
receiving a set-point temperature value at a fuel control system of a cooking device;
heating a heat sink with heat from a cooking liquid held by a vessel of the cooking device, the heat sink being in contact with a wall surface of the vessel;
transferring the heat from the heat sink to a capillary tube to cause an expansion of a fluid inside the capillary tube; and
adjusting a fuel valve of the fuel control system using the expansion of the fluid inside the capillary tube to apply pressure on a diaphragm fluidly coupled to one or more burners disposed below the vessel, an amount of fuel provided to the one or more burners by the fuel valve being responsive to heating the heat sink.

19. The method of claim 18, further comprising:
detecting, with one or more sensors thermally coupled to the cooking liquid, a real-time temperature value of the cooking liquid;
determining that the real-time temperature value is greater than the set-point temperature value;
closing the fuel valve of the fuel control system in response to the real-time temperature value being greater than the set-point temperature value; and
continuing to provide fuel to an ignited secondary burner while closing the fuel valve.

20. The method of claim 18, further comprising:
detecting, with one or more sensors thermally coupled to the cooking liquid, a real-time temperature value corresponding to the cooking liquid;
retrieving a predetermined threshold value, the predetermined threshold value being between 375° and 450° Fahrenheit;
determining whether the real-time temperature value is above the predetermined threshold value; and
closing the fuel valve in response to determining whether the real-time temperature value is above a predetermined threshold value, the predetermined threshold value being between 375° and 450° Fahrenheit.
